(19) United States
(12) Patent Application Publication
(10) Pub. No.: US 2014/0232713 A1
(43) Pub. Date: Aug. 21, 2014

(54) DISPLAY DRIVING APPARATUS AND METHOD FOR DRIVING DISPLAY PANEL

(71) Applicant: Novatek Microelectronics Corp., Hsinchu (TW)

(72) Inventors: Che-Lun Hsu, Hsinchu County (TW); Keko-Chun Liang, Hsinchu City (TW)

(73) Assignee: Novatek Microelectronics Corp., Hsinchu (TW)

(21) Appl. No.: 14/016,144

(22) Filed: Sep. 2, 2013

(30) Foreign Application Priority Data
Feb. 20, 2013 (TW) 102105908

(51) Int. Cl. G09G 3/36

(52) U.S. Cl. CPC G09G 3/3696
USPC 345/213; 345/99

(57) ABSTRACT

A display driving apparatus configured to drive a display panel is provided. The display driving apparatus includes a plurality of source drivers. The source drivers are configured to output a video image data to drive the display panel. Each of the source drivers includes a plurality of driving channels. Each of the source drivers randomly turns on at least one of the included driving channels via a control signal, so as to allow the driving channels outputting the video image data. In each of the source drivers, at least a part of the driving channels are randomly turned on to output the video image data. Furthermore, a method for driving the display panel of the foregoing display driving apparatus is also provided.

### CROSS-REFERENCE TO RELATED APPLICATION

This application claims the priority benefit of Taiwan application serial no. 102105908, filed on Feb. 20, 2013. The entirety of the above-mentioned patent application is hereby incorporated by reference herein and made a part of this specification.

### BACKGROUND

1. Technical Field

The disclosure relates to a display driving apparatus and a method for driving a display panel. Particularly, the disclosure relates to a driving apparatus of a liquid crystal display and a method for driving a liquid display panel.

2. Related Art

Generally, a source driver configured to drive a display panel includes a plurality of driving channels, and each of the driving channels includes a latch, a digital-to-analog converter (DAC), an output buffer and an output switch. Digital image data on a data bus is input to the driving channels of the source driver according to a timing control signal provided by a timing controller. The source driver uses the DAC to convert the digital image data into an analog driving signal, and transmits the analog driving signal to the output buffer. The output buffer further enhances the analog driving signal and transmits the analog driving signal to the display panel through the turned on output switch. In this way, the image data is transmitted to the display panel. However, in the driving channels of the conventional display driving apparatus, the output switches are simultaneously turned on at a specific time point, and now all of the output buffers simultaneously output the analog driving signal at the specific time point, and as a result, the display panel and the driving apparatus thereof are liable to be influenced by electromagnetic interference (EMI).

### SUMMARY

The disclosure is directed to a display driving apparatus, which is capable of decreasing electromagnetic interference (EMI).

The disclosure is directed to a method for driving a display panel, by which electromagnetic interference (EMI) is decreased.

The disclosure provides a display driving apparatus configured to drive a display panel. The display driving apparatus includes a plurality of source drivers.

The source drivers are configured to output video image data to drive the display panel. Each of the source drivers includes a plurality of driving channels. Each of the source drivers randomly turns on at least one of the included driving channels through a control signal, so as to allow the driving channels outputting the video image data. In each of the source drivers, at least a part of the driving channels are randomly turned on at different timing, so as to output the video image data.

In an embodiment of the disclosure, the display driving apparatus further includes a timing controller. The timing controller is coupled to the source drivers. The timing controller includes a random number generator. The random number generator is configured to generate a random number signal to each of the source drivers. Each of the source drivers randomly turns on at least one of the included driving channels according to the random number signal.

In an embodiment of the disclosure, each of the source drivers further includes a random delay generator. The random delay generator is configured to randomly delay a phase of the control signal according to the random number signal, so as to randomly turn on the driving channels at different timing.

In an embodiment of the disclosure, each of the source drivers randomly turns on the driving channels at different timing by adjusting a phase of the control signal.

In an embodiment of the disclosure, each of the driving channels includes an output buffer and an output switch. The output buffer has a first input terminal, a second input terminal and an output terminal. The first input terminal receives the video image data. The second input terminal is coupled to the output terminal. The output switch has a first terminal, a second terminal and a control terminal. The first terminal is coupled to the output terminal, the second terminal is coupled to the display panel, and the control terminal is controlled by the control signal. Each of the source drivers controls a conducting state of the output switches through the control signal, so as to turn on or turn off the driving channels.

In an embodiment of the disclosure, when each of the source drivers randomly turns on at least one of the included driving channels through the control signal, in the source drivers, the driving channels simultaneously receiving the control signal are turned on under control of the control signal with the same phase.

In an embodiment of the disclosure, when each of the source drivers randomly turns on at least one of the included driving channels through the control signal, in the source drivers, the driving channels simultaneously receiving the control signal are turned on under control of the control signal with different phases.

In an embodiment of the disclosure, in each of the source drivers, the randomly turned on driving channels are controlled by the control signal with the same phase.

In an embodiment of the disclosure, in the source drivers, the initially turned on driving channels are controlled by the control signal with different phases.

In an embodiment of the disclosure, in the source drivers, the initially turned on driving channels are controlled by the control signal with the same phase.

The disclosure provides a method for driving a display panel, which is adapted to a display driving apparatus. The display driving apparatus includes a plurality of source drivers, and each of the source drivers includes a plurality of driving channels. The method includes following steps. Video image data is received. At least one of the driving channels included in each of the source drivers is randomly turned on through a control signal. The video image data is output through the at least one driving channel randomly turned on in each of the source drivers to drive the display panel. In each of the source drivers, at least a part of the driving channels are randomly turned on at different timing, so as to output the video image data.

In an embodiment of the disclosure, the aforementioned method further includes following steps. A random number signal is generated to each of the source drivers. At least one of the driving channels included in each of the source drivers is randomly turned on according to the random number signal.

In an embodiment of the disclosure, the step of randomly turning on at least one of the driving channels included in each of the source drivers includes following steps. A phase of the control signal is randomly delayed according to the random number signal, so as to randomly turn on the driving channels at different timing.

In an embodiment of the disclosure, the step of randomly turning on at least one of the driving channels included in each of the source drivers includes following steps. The driving channels included in each of the source drivers are randomly turned on at different timing by adjusting a phase of the control signal.

In an embodiment of the disclosure, when at least one of the driving channels included in each of the source drivers is randomly turned on through the control signal, in the source drivers, the driving channels simultaneously receiving the control signal are turned on under control of the control signal with the same phase.

In an embodiment of the disclosure, when at least one of the driving channels included in each of the source drivers is randomly turned on through the control signal, in the source drivers, the driving channels simultaneously receiving the control signal are turned on under control of the control signal with different phases.

In an embodiment of the disclosure, in each of the source drivers, the randomly turned on driving channels are controlled by the control signal with the same phase.

In an embodiment of the disclosure, in the source drivers, the initially turned on driving channels are controlled by the control signal with different phases.

In an embodiment of the disclosure, in the source drivers, the initially turned on driving channels are controlled by the control signal with the same phase.

According to the above descriptions, in the exemplary embodiments of the disclosure, the driving channels of each source drive are randomly turned on at different timing to output the video image data, so as to decrease the EMI.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a display driving apparatus according to an embodiment of the disclosure.

FIG. 2 is a schematic diagram of a plurality of driving channels included in a source driver of FIG. 1.

FIG. 3 is a schematic diagram of an output waveform of an output buffer of FIG. 2 and a signal waveform of a control signal.

FIG. 4 is a schematic diagram of randomly turning on driving channels according to an embodiment of the disclosure.

FIG. 5-FIG. 9 are schematic diagrams of randomly turning on driving channels according to other embodiments of the disclosure.

FIG. 10 is a flowchart illustrating a method for driving a display panel according to an embodiment of the disclosure.

### DETAILED DESCRIPTION OF DISCLOSED EMBODIMENTS

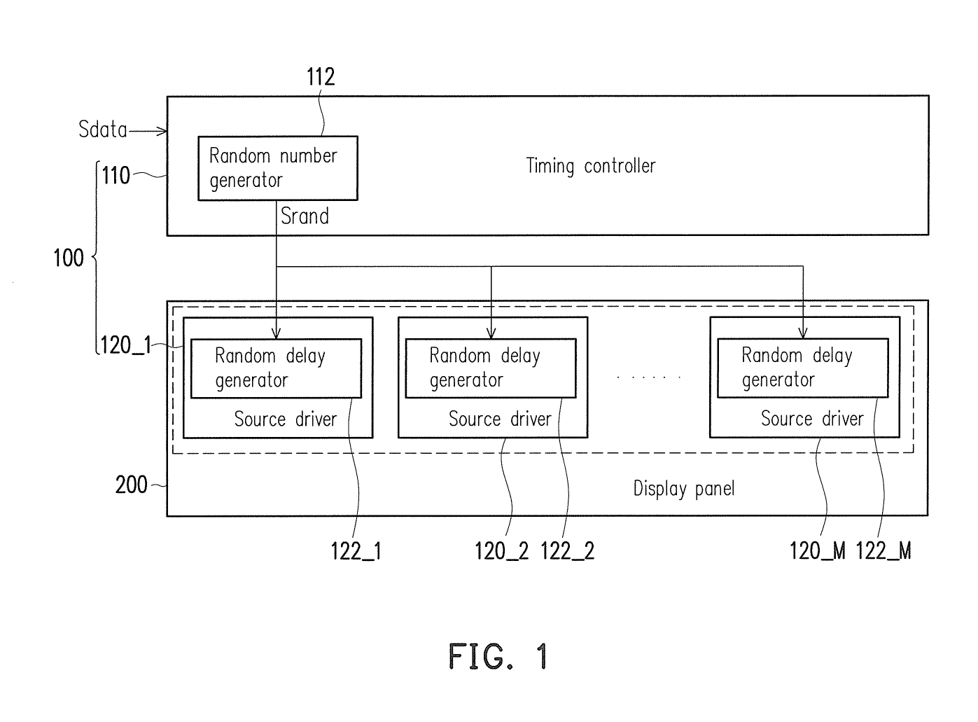

FIG. 1 is a schematic diagram of a display driving apparatus according to an embodiment of the disclosure. Referring to FIG. 1, the display driving apparatus 100 of the present embodiment is configured to drive a display panel 200 according to video image data Sdata. In the present embodiment, the display driving apparatus 100 includes a timing controller 110 and a plurality of source drivers 120_1-120_M. The timing controller 110 is configured to provide timing control signals (not shown) and the video image data Sdata to the source drivers 120_1-120_M, and the source drivers 120_1-120_M output the video image data Sdata in proper timing to drive the display panel 200.

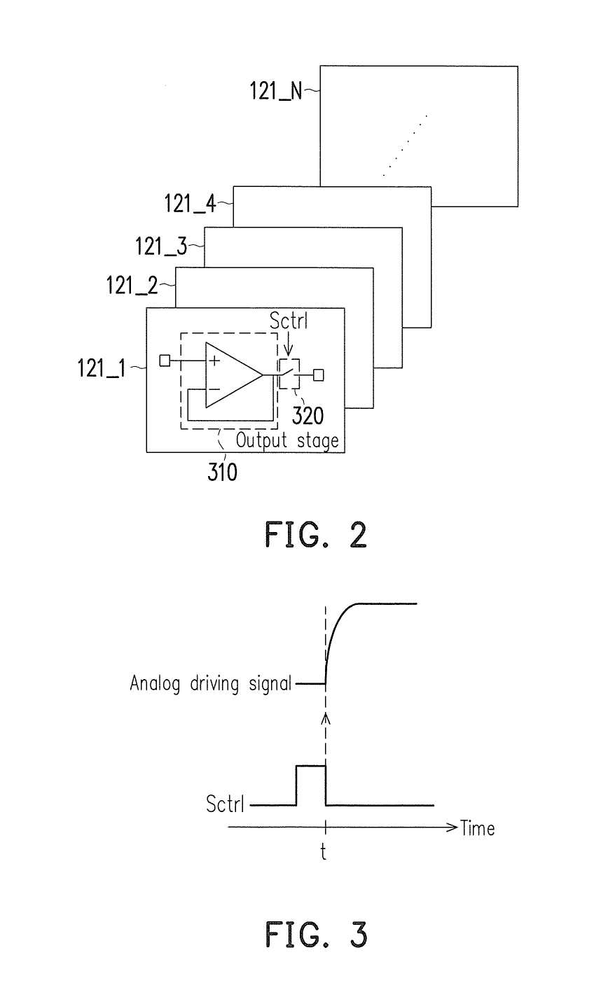

In detail, FIG. 2 is a schematic diagram of a plurality of driving channels included in a source driver of FIG. 1. Referring to FIG. 2, the source drivers 120_1-120_M of the present embodiment, for example, respectively include driving channels 121_1-121_N. Generally, the driving channel of the source driver generally includes a latch, a digital-to-analog converter (DAC), an output buffer and an output switch. For simplicity's sake, only the output buffer and the output switch located at an output stage of the driving channel are illustrated in FIG. 2. Tacking the driving channel 121_1 as an example, the driving channel 121_1 of the present embodiment includes an output buffer 310 and an output switch 320. A first input terminal (+) of the output buffer 310 receives an analog driving signal provided by a DAC (not shown) of a previous stage, where the analog driving signal is obtained after the DAC converts the video image data Sdata. A second input terminal (−) of the output buffer 310 is coupled to an output terminal thereof to form a configuration of voltage follower, and such configuration is only used as an example, and the disclosure is not limited thereto. The output buffer 310 is configured to enhance the received analog driving signal and transmit the analog driving signal to the display panel 200 through the turned on output switch 320, and the display panel 200 accordingly displays a display image corresponding to the video image data Sdata. A first terminal of the output switch 320 is coupled the output terminal of the output buffer 310, and a second terminal of the output switch 320 is coupled to a corresponding pixel column in the display panel 200. A control terminal of the output switch 320 is controlled by a control signal Sctrl. The turned on output switch 320 can transmit the analog driving signal to the pixel column coupled thereto. In the present embodiment, each of the source drivers controls a conducting state of the output switch through the control signal Sctrl, so as to turn on or turn off the driving channels included in the source driver.

FIG. 3 is a schematic diagram of an output waveform of the output buffer of FIG. 2 and a signal waveform of the control signal. Referring to FIG. 3, the control signal Sctrl of the present embodiment is, for example, a square wave pulse, the output buffer 310 generally outputs the analog driving signal at a time point t1, and the output waveform thereof is as that shown in FIG. 3. Generally, in an application with increasingly fast operating frequency, if a driving method of the display driving apparatus 100 is not accordingly adjusted, the driving channels of each of the source drivers are probably turned on simultaneously, and all of the output buffers simultaneously output the analog driving signal at the specific time point t, and as a result, the display panel 200 and the display driving apparatus 100 are subject to severe EMI. Therefore, in the present embodiment, the source drivers 120_1-120_M randomly turn on at least one of the driving channels 121_1-121_N included therein through the control signal Sctrl, so as to allow the turned on driving channels outputting the analog driving signal. Therefore, in each of the source drives, at least a part of the driving channels are turned on at different timing, so as to decrease the EMI.

How each of the source drivers randomly turns on the included driving channels through the control signal is described below.

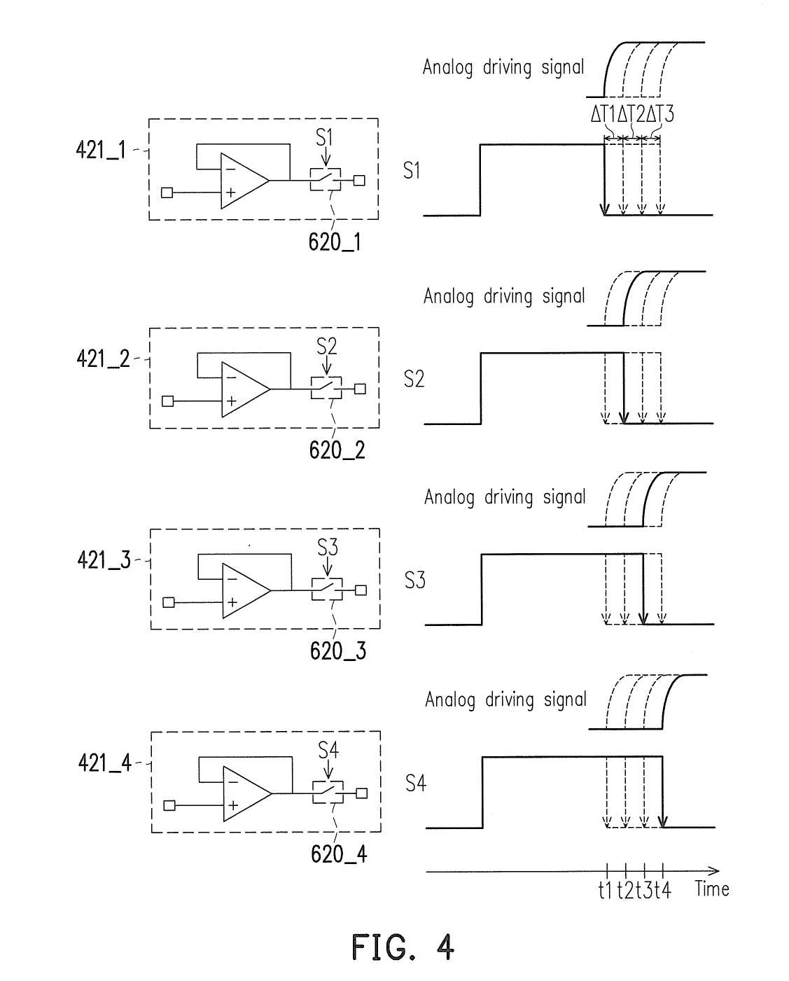

FIG. 4 is a schematic diagram of randomly turning on driving channels according to an embodiment of the disclosure. Referring to FIG. 4, a method of randomly turning on the driving channels of the present embodiment is, for example, to randomly turn on the driving channels of each of the source drivers at different timing by adjusting a phase of the control signal Sctrl. In the present embodiment, four driving channels 421_1-421_4 of the source driver 120_1 are taken as an example for descriptions. After the phase of the control signal Sctrl is adjusted, the control signal Sctrl, for example, includes four control signals S1-S4 respectively used to control output switches 620_1-620_4. In the present embodiment, the output switches 620_1-620_4 are respectively turned on at falling edges of the control signals S1-S4, which is indicated by an arrow of each control signal waveform of FIG. 4.

In the present embodiment, falling timing of the control signals S1-S4 are sequentially delayed by a phase delay time ΔT1, ΔT2 and ΔT3, respectively. Namely, the phase of the control signal S2 is delayed by the phase delay time ΔT1 compared with that of the control signal S1, the phase of the control signal S3 is delayed by the phase delay time ΔT2 compared with that of the control signal S2, and the phase of the control signal S4 is delayed by the phase delay time ΔT3 compared with that of the control signal S3. The phase delay can be implemented through a random delay generator 122_1 in internal of the source driver 120_1. It should be noticed that time lengths of the phase delay time ΔT1, ΔT2 and ΔT3 can be equal or unequal. Therefore, the different driving channels 421_1, 421_2, 421_3 and 421_4 randomly output the analog driving signal at different time points t1, t2, t3 and t4 along with time variation, so as to stagger outputting timing of each of the driving channels to decrease the EMI generated when all of the driving channels simultaneously output signals.

Moreover, in the present embodiment, although the method for randomly turning on the driving channels of the present embodiment is to use a phase modulation method to sequentially modulate the control signals S1-S4 into four phases according to the phase delay time ΔT1, ΔT2 and ΔT3, the disclosure is not limited thereto, and in another embodiment, the phase delay relationship between the control signals S1-S4 may also have other different patterns.

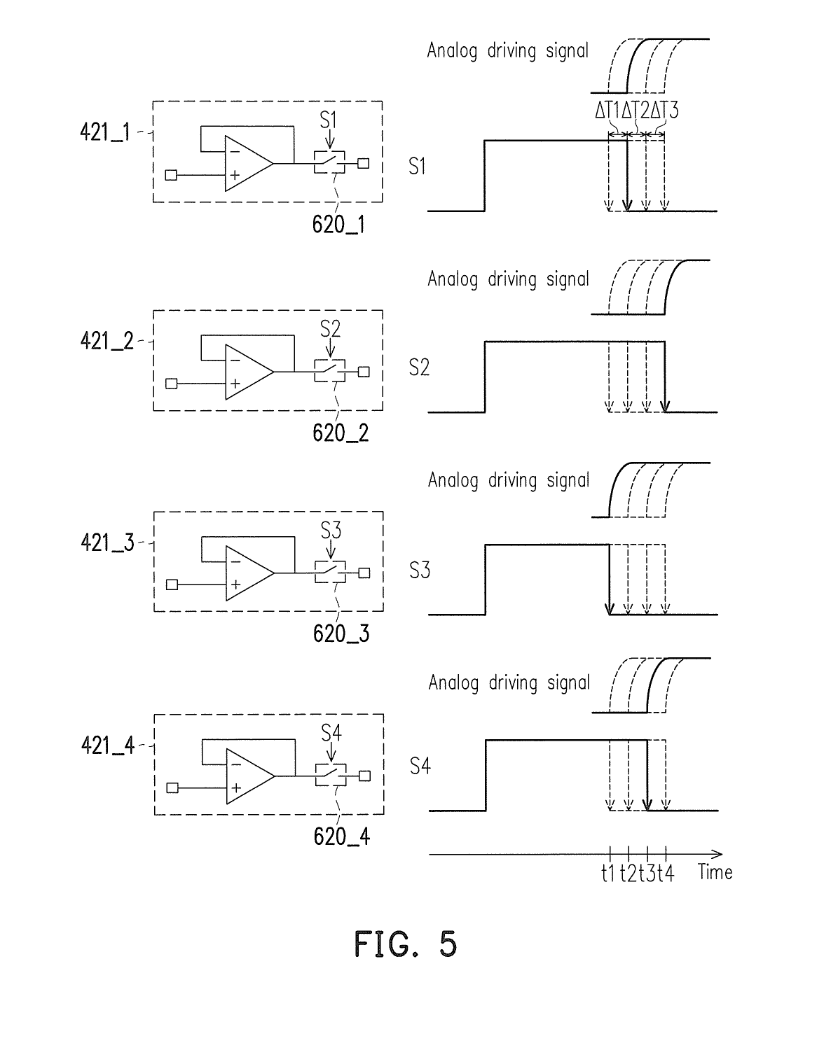

FIG. 5 is a schematic diagram of randomly turning on driving channels according to another embodiment of the disclosure. Referring to FIG. 5, the method of randomly turning on the driving channels of the present embodiment is also to randomly turn on the driving channels of each of the source drivers at different timing by adjusting a phase of the control signal Sctrl. The four driving channels 421_1-421_4 of FIG. 4 are taken as an example for descriptions. Falling timing of the control signals S1-S4 of FIG. 5 are sequentially delayed by a phase delay time ΔT1, ΔT2 and ΔT3, respectively. Namely, the phase of the control signal S4 is delayed by the phase delay time ΔT1 compared with that of the control signal S2, the phase of the control signal S1 is delayed by the phase delay time ΔT2 compared with that of the control signal S4, and the phase of the control signal S3 is delayed by the phase delay time ΔT3 compared with that of the control signal S1. In view of a whole phase delay relationship of the control signal, the driving channels 421_1, 421_2, 421_3 and 421_4 randomly output the analog driving signal at different time points t1, t2, t3 and t4 along with time variation, so as to stagger outputting timing of each of the driving channels to decrease the EMI.

Moreover, in the embodiments of FIG. 4 and FIG. 5, although the method for randomly turning on the driving channels is to use the phase modulation method to modulate the control signals S1-S4 into four phases according to the phase delay time ΔT1, ΔT2 and ΔT3, the number of modulated phases is not limited by the disclosure, and in other embodiments, by using a plurality of the same or different phase delay time, the control signal can be modulated to have N different phases, and delays between the phases can be equal or unequal, where N is a positive integer greater than 1. Therefore, based on the phase modulation, the control signal can be modulated to have N different phases, such that a frequency component of each phase is changed to 1/N, so as to decrease the EMI. It should be noticed that in the disclosure, the number of the modulated phases can be greater than, equal to or smaller than the number of the driving channels of each of the source drivers. Moreover, based on such phase modulation, the original control signal can be used to achieve the effect of staggering outputting timing of the driving channels to save a signal tracing area.

Referring to FIG. 1, in the embodiments of FIG. 4 and FIG. 5, the phase delay can be implemented through random delay generators 122_1-122_M in internal of the source drivers 120_1-120_M. The random delay generators 122_1-122_M randomly delay the phase of the control signal Sctrl according to a random number signal Srand, so as to randomly turn on the included driving channels at different timing. In the present embodiment, the timing controller 110 includes a random number generator 112. The random number generator 112 is configured to generate the random number signal Srand to each of the source drivers. The source drivers 120_1-120_M randomly turns on one of the included driving channels according to the random number signal Srand.

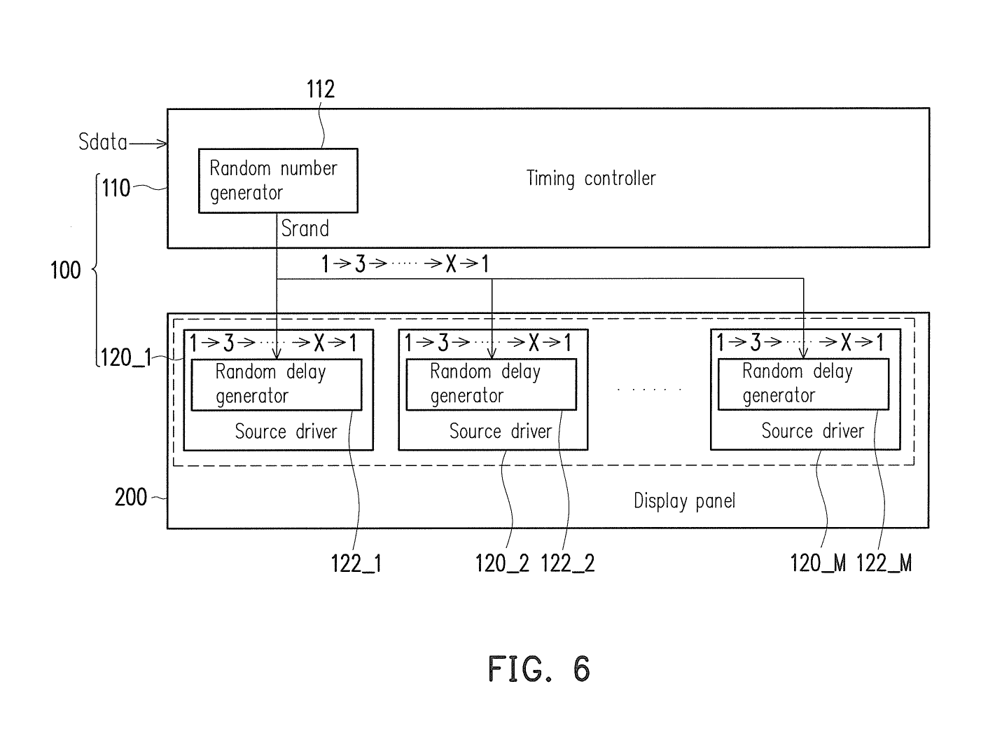

Further, FIG. 6 is a schematic diagram of randomly turning on the driving channels according to an embodiment of the disclosure. Referring to FIG. 6, the random delay generators 122_1-122_M of the present embodiment randomly delay the phase of the control signal Sctrl according to the random number signal Srand. In FIG. 6, on a signal transmission path of the random number signal Srand, an indicated symbol [1→3→ . . . →X→1] represents a sequence of the random numbers generated by the random number generator 112, which is 1, 3, . . . , X, 1, and the random number signal Srand including the sequence information is transmitted to the source drivers 120_1-120_M, where X is a positive integer. Then, the source drivers 120_1-120_M receives the random number sequence, and the random delay generators 122_1-122_M in internal of the source drivers 120_1-120_M randomly delay the phase of the control signals Sctrl according to the random number sequence of the random number signal Srand.

In the present embodiment, when each of the source drivers turns on at least one of the included driving channels through the control signal, in the source driver, the driving channels simultaneously receiving the control signal Sctrl are turned on under control of the control signal with the same phase. For example, at an initial timing, the random numbers received by the source drivers 120_1-120_M are the same, which are all 1. Now, a phase delay situation of the control signal Sctrl implemented by each of the source drivers 120_1-120_M is shown as the signal waveform of the control signal S1 of FIG. 4, where the phase of the control signal Sctrl is not delayed. Therefore, at the initial timing, the driving channels simultaneously receiving the control signal Sctrl are turned on under control of the control signal with undelayed phase.

Then, at a next timing of the initial timing, the random numbers received by the source drivers 120_1-120_M are the same, which are all 3. Now, a phase delay situation of the control signal Sctrl implemented by each of the source drivers 120_1-120_M is shown as the signal waveform of the control signal S3 of FIG. 4, where the phase of the control signal Sctrl is delayed by two phase delay time. At such timing, the driving channels simultaneously receiving the control signal Sctrl are turned on under control of the control signal with phase delayed by two phase delay time. As time goes on, the phase delay situations of the control signal Sctrl of other timing can be deduced by analogy, which are not repeated. Therefore, in the present embodiment, the number sequence indicated on each of the source drivers represents the phase delay situations of the control signal Sctrl of each of the source drivers.

Therefore, in view of all of the source drivers, in the present embodiment, the driving channels simultaneously receiving the control signal Sctrl are turned on under control of the control signal with the same phase. According to another aspect, regarding a single source driver, as time goes on, each of the source drivers modulates the control signal Sctrl into different phases.

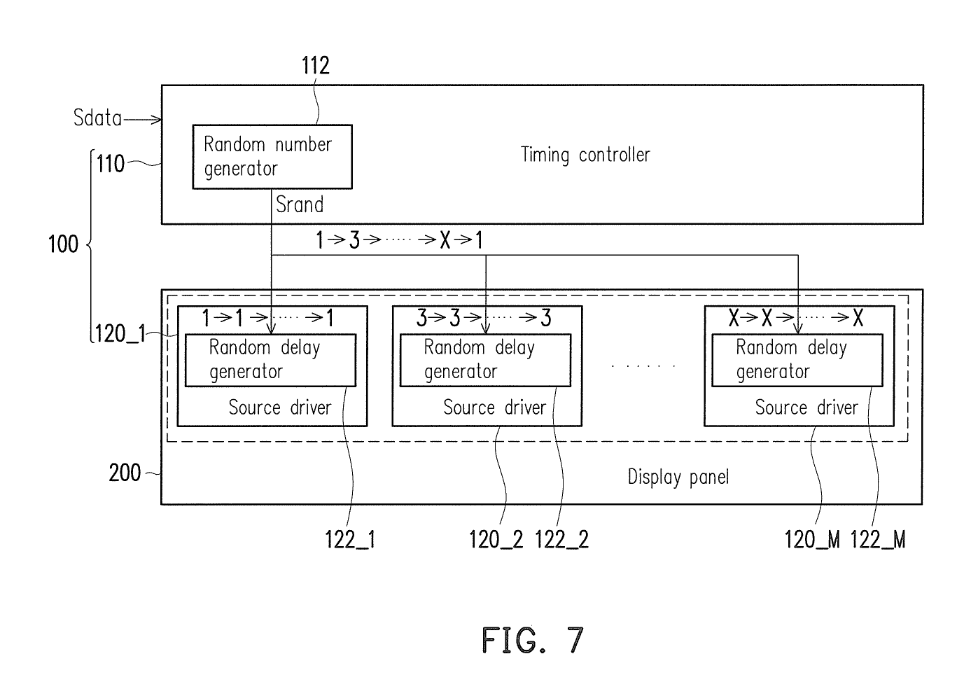

FIG. 7 is a schematic diagram of randomly turning on the driving channels according to another embodiment of the disclosure. Referring to FIG. 7, the random delay generators 122_1-122_M of the present embodiment randomly delay the phase of the control signal Sctrl according to the random number signal Srand. In FIG. 7, the random number signal Srand transmitted to the source drivers 120_1-120_M also includes sequence information [1→3→ . . . →X→1] of random numbers.

Different to the embodiment of FIG. 6, in the present embodiment, when each of the source drivers turns on at least one of the included driving channels through the control signal, in the source driver, the driving channels simultaneously receiving the control signal Sctrl are turned on under control of the control signal with different phases. Moreover, in each of the source drivers, the randomly turned on driving channels are controlled by the control signal with the same phase.

For example, at any timing, the random numbers received by the source drivers 120_1-120_M are different, which are respectively 1, 3, . . . , X. Therefore, a phase delay situation of the control signal Sctrl implemented by the source driver 120_1 is shown as the signal waveform of the control signal S1 of FIG. 4, and a phase delay situation of the control signal Sctrl implemented by the source driver 120_2 is shown as the signal waveform of the control signal S3 of FIG. 4, and phase delay situations of the control signal Sctrl implemented by the other source drivers can be deduced by analogy, which are not repeated. Therefore, in the present embodiment, the driving channel turned on by the control signal Sctrl in the source driver 120_2 is delayed by two phase delay time to output the analogy driving signal compared with the driving channel turned on by the control signal Sctrl in the source driver 120_1. The driving channel turned on by the control signal Sctrl in the source driver 120_M is delayed by X-1 phase delay time to output the analogy driving signal compared with the driving channel turned on by the control signal Sctrl in the source driver 120_1. The phase delay situations of the control signal Sctrl implemented by the other source drivers can be deduced by analogy, which are not repeated.

Therefore, in view of all of the source drivers, in the present embodiment, the driving channels simultaneously receiving the control signal Sctrl are controlled by the control signal with the same phase. According to another aspect, regarding a single source driver, as time goes on, each of the source drivers modulates the control signal Sctrl into the same phase. Therefore, in each of the source drivers, the randomly turned on driving channels are controlled by the control signal with the same phase. For example, in the source driver 120_1, the randomly turned on driving channels are controlled by the control signal Sctrl with undelayed phase, for example, the control signal S1 of FIG. 4. In the source driver 1202, the randomly turned on driving channels are controlled by the control signal Sctrl with phase delayed by two phase delay time, for example, the control signal S3 of FIG. 4.

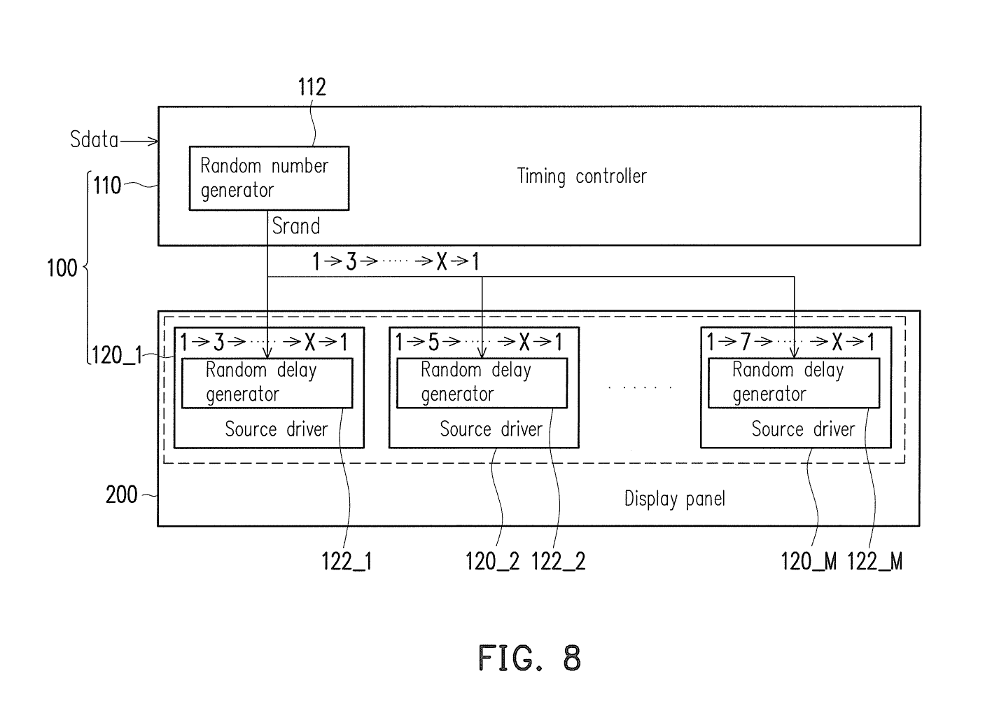

FIG. 8 is a schematic diagram of randomly turning on the driving channels according to another embodiment of the disclosure. Referring to FIG. 8, the random delay generators 122_1-122_M of the present embodiment randomly delay the phase of the control signal Sctrl according to the random number signal Srand. In FIG. 8, the random number signal Srand transmitted to the source drivers 120_1-120_M also includes sequence information [1→3→ . . . →X→1] of random numbers. Different to the embodiment of FIG. 7, in the present embodiment, in each of the source drivers, the randomly turned on driving channels are controlled by the control signal with different phases.

For example, at the initial timing, the random number received by the source driver 120_1 is 1. Now, a phase delay situation of the control signal Sctrl implemented by the source driver 120_1 is shown as the signal waveform of the control signal S1 of FIG. 4, where the phase of the control signal Sctrl is not delayed. Therefore, at the initial timing, the driving channels simultaneously receiving the control signal Sctrl are turned on under control of the control signal with undelayed phase. Then, at a next timing of the initial timing, the random number received by the source driver 120_1 is 3. Now, a phase delay situation of the control signal Sctrl implemented by the source driver 120_1 is shown as the signal waveform of the control signal S3 of FIG. 4, where the phase of the control signal Sctrl is delayed by two phase delay time. At such timing, the driving channels receiving the control signal Sctrl are turned on under control of the control signal with phase delayed by two phase delay time. As time goes on, the phase delay situations of the control signal Sctrl implemented by the source driver 120_1 at other timing can be deduced by analogy, which are not repeated. Moreover, the phase delay situations of the control signal Sctrl of the other source drivers can be deduced by analogy with reference of the number sequence indicated on each of the source drivers in FIG. 8, which are not repeated.

It should be noticed that at the initial timing, the random numbers received by the source drivers 120_1-120_M are all the same, which are all 1, and a phase delay situation of the control signal Sctrl implemented by each of the source drivers 120_1-120_M is shown as the signal waveform of the control signal S1 of FIG. 4. Therefore, in the present embodiment, the initially turned on driving channels of the source drivers 120_1-120_M are controlled by the control signal of the same phase, though the disclosure is not limited thereto, and in another embodiment, the initially turned on driving channels of the source drivers 120_1-120_M can be controlled by the controls signal of different phases.

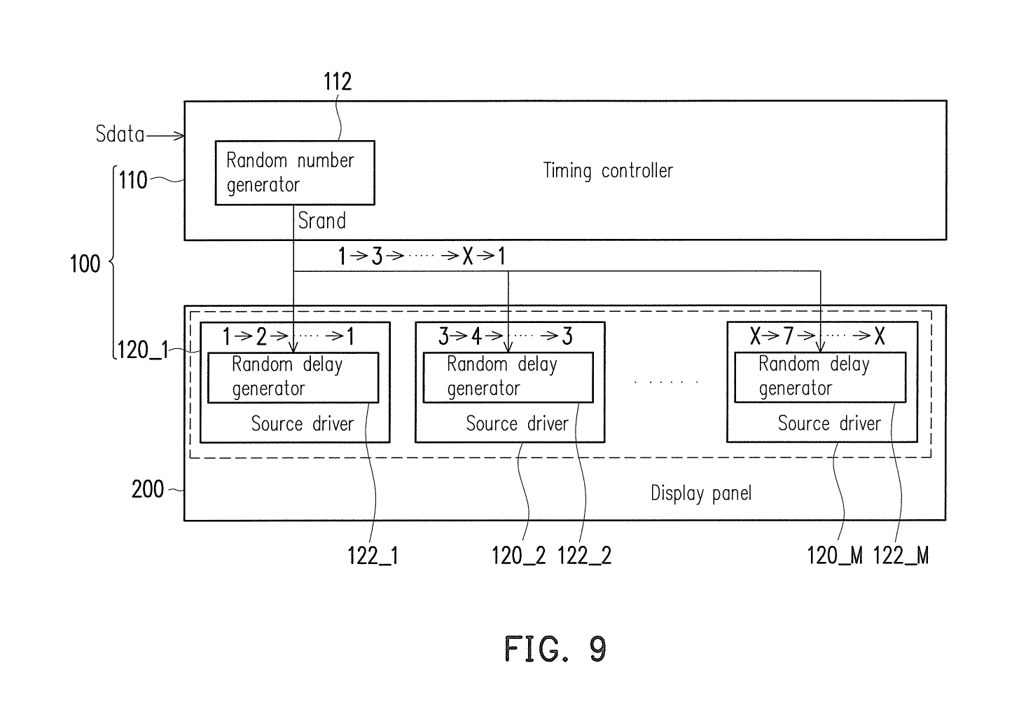

FIG. 9 is a schematic diagram of randomly turning on driving channels according to another embodiment of the disclosure. Referring to FIG. 9, the random delay generators 122_1-122_M of the present embodiment randomly delay the phase of the control signal Sctrl according to the random number signal Srand. In FIG. 9, the random number signal Srand transmitted to the source drivers 120_1-120_M also includes sequence information [1→3→ . . . →X→1] of random numbers. Different to the embodiment of FIG. 8, in the present embodiment, the initially turned on driving channels of the source drivers 120_1-120_M are controlled by the control signal with different phases.

For example, at the initial timing, the random number received by the source driver 120_1 is 1, which represents that a phase delay situation of the control signal Sctrl implemented by the source driver 120_1 is shown as the signal waveform of the control signal S1 of FIG. 4. Meanwhile, the random number received by the source driver 120_2 is 3, which represents that a phase delay situation of the control signal Sctrl implemented by the source driver 120_1 at the initial timing is shown as the signal waveform of the control signal S3 of FIG. 4. The phase delay situations of the control signal Sctrl of the other source drivers at the initial timing can be deduced by analogy with reference of the number sequence indicated on each of the source drivers in FIG. 9, which are not repeated.

It should be noticed that, in the embodiments of FIG. 6 to FIG. 9, a number X of the phases modulated by the source drivers can be greater than, equal to or smaller than the number of the driving channels of each of the source drivers.

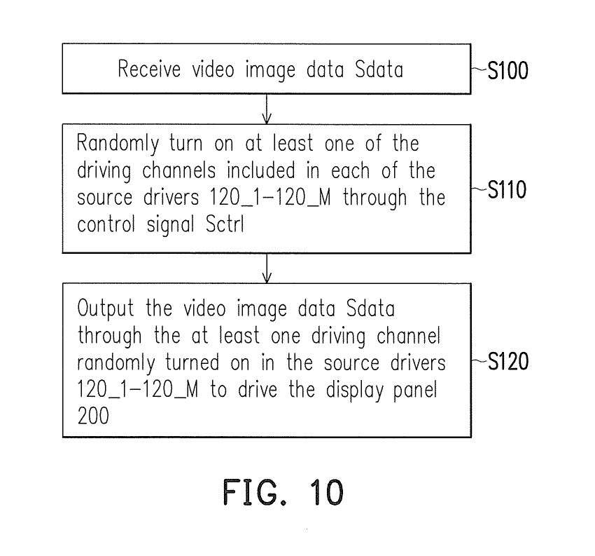

FIG. 10 is a flowchart illustrating a method for driving a display panel according to an embodiment of the disclosure. Referring to FIG. 1 and FIG. 10, the method for driving the display panel of the present embodiment includes following steps. First, in step S100, the video image data Sdata is received. Then, in step S110, at least one of the driving channels included in each of the source drivers 120_1-120_M is randomly turned on through the control signal Sctrl. Then, in step S120, the video image data Sdata is output through the at least one driving channel randomly turned on in the source drivers 120_1-120_M to drive the display panel 200. Therefore, in the present embodiment, at least a part of the driving channels of each of the source drivers are randomly turned on at different timing, so as to output the video image data Sdata.

Moreover, those skilled in the art can learn enough instructions and recommendations for the method for driving the display panel of the present embodiment from the descriptions of the embodiments of FIG. 1 to FIG. 9, so that detailed description thereof is not repeated.

In summary, in the exemplary embodiments of the disclosure, the driving channels of each source drive are randomly turned on at different timing to output the video image data, so as to decrease the EMI generated when all of the driving channels simultaneously output the video image data.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A display driving apparatus, configured to drive a display panel, the display driving apparatus comprising:
a plurality of source drivers, configured to output video image data to drive the display panel, wherein each of the source drivers comprises:
a plurality of driving channels, each of the source drivers randomly turning on at least one of the comprised driving channels through a control signal, so as to allow the at least one driving channel outputting the video image data,
wherein in each of the source drivers, at least a part of the driving channels are randomly turned on at different timing, so as to output the video image data.

2. The display driving apparatus as claimed in claim 1, further comprising:
a timing controller, coupled to the source drivers, and comprising a random number generator, wherein the random number generator is configured to generate a random number signal to each of the source drivers,
wherein each of the source drivers randomly turns on at least one of the comprised driving channels according to the random number signal.

3. The display driving apparatus as claimed in claim 2, wherein each of the source drivers further comprises:
a random delay generator, configured to randomly delay a phase of the control signal according to the random number signal, so as to randomly turn on the driving channels at different timing.

4. The display driving apparatus as claimed in claim 1, wherein each of the source drivers randomly turns on the driving channels at different timing by adjusting a phase of the control signal.

5. The display driving apparatus as claimed in claim 1, wherein each of the driving channels comprises:
an output buffer, having a first input terminal, a second input terminal and an output terminal, wherein the first input terminal receives the video image data, and the second input terminal is coupled to the output terminal; and
an output switch, having a first terminal, a second terminal and a control terminal, wherein the first terminal is coupled to the output terminal, the second terminal is coupled to the display panel, and the control terminal is controlled by the control signal,
wherein each of the source drivers controls a conducting state of the output switches through the control signal, so as to turn on or turn off the driving channels.

6. The display driving apparatus as claimed in claim 1, wherein when each of the source drivers randomly turns on at least one of the comprised driving channels through the control signal, in the source drivers, the driving channels simultaneously receiving the control signal are turned on under control of the control signal with the same phase.

7. The display driving apparatus as claimed in claim 1, wherein when each of the source drivers randomly turns on at least one of the comprised driving channels through the control signal, in the source drivers, the driving channels simultaneously receiving the control signal are turned on under control of the control signal with different phases.

8. The display driving apparatus as claimed in claim 7, wherein in each of the source drivers, the randomly turned on driving channels are controlled by the control signal with the same phase.

9. The display driving apparatus as claimed in claim 7, wherein in the source drivers, the initially turned on driving channels are controlled by the control signal with different phases.

10. The display driving apparatus as claimed in claim 7, wherein in the source drivers, the initially turned on driving channels are controlled by the control signal with the same phase.

11. A method for driving a display panel, adapted to a display driving apparatus, wherein the display driving apparatus comprises a plurality of source drivers, and each of the source drivers comprises a plurality of driving channels, the method for driving the display panel comprising:
receiving video image data;
randomly turning on at least one of the driving channels comprised in each of the source drivers through a control signal; and
outputting the video image data through the at least one driving channel randomly turned on in each of the source drivers to drive the display panel,
wherein in each of the source drivers, at least a part of the driving channels are randomly turned on at different timing, so as to output the video image data.

12. The method for driving the display panel as claimed in claim 11, further comprising:
generating a random number signal to each of the source drivers; nad
randomly turning on at least one of the driving channels comprised in each of the source drivers according to the random number signal.

13. The method for driving the display panel as claimed in claim 12, wherein the step of randomly turning on at least one of the driving channels comprised in each of the source drivers comprises:
randomly delaying a phase of the control signal according to the random number signal, so as to randomly turn on the driving channels at different timing.

14. The method for driving the display panel as claimed in claim 11, wherein the step of randomly turning on at least one of the driving channels included in each of the source drivers comprises:
randomly turning on the driving channels comprised in each of the source drivers at different timing by adjusting a phase of the control signal.

15. The method for driving the display panel as claimed in claim 11, wherein when at least one of the driving channels comprised in each of the source drivers is randomly turned on through the control signal, in the source drivers, the driving channels simultaneously receiving the control signal are turned on under control of the control signal with the same phase.

16. The method for driving the display panel as claimed in claim 11, wherein when at least one of the driving channels comprised in each of the source drivers is randomly turned on through the control signal, in the source drivers, the driving channels simultaneously receiving the control signal are turned on under control of the control signal with different phases.

17. The method for driving the display panel as claimed in claim 16, wherein in each of the source drivers, the randomly turned on driving channels are controlled by the control signal with the same phase.

18. The method for driving the display panel as claimed in claim 16, wherein in the source drivers, the initially turned on driving channels are controlled by the control signal with different phases.

19. The method for driving the display panel as claimed in claim 16, wherein in the source drivers, the initially turned on driving channels are controlled by the control signal with the same phase.
